(19) United States
(12) Patent Application Publication
(10) Pub. No.: US 2010/0001904 A1
(43) Pub. Date: Jan. 7, 2010

(54) RADIO COMMUNICATION APPARATUS AND SYSTEM

(75) Inventor: Takanori IWAMATSU, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: Fujitsu Limited, Kawasaki (JP)

(21) Appl. No.: 12/496,451

(22) Filed: Jul. 1, 2009

(30) Foreign Application Priority Data
Jul. 2, 2008 (JP) 2008-174003

(51) Int. Cl. H01Q 3/00

(52) U.S. Cl. 342/372

(57) ABSTRACT

A radio communication apparatus includes a vertical polarization antenna, a horizontal polarization antenna, a receiving-side phase rotation unit configured to rotate a phase of a signal received by the vertical polarization antenna and a phase of a signal received by the horizontal polarization antenna, and a maximum power detector configured to determine a phase associated with a maximum power of the two received signals and to provide the receiving-side phase rotation unit with the phase associated with the maximum power. The receiving-side phase rotation unit rotates the phase of the two received signals by the phase associated with the maximum power.

### CROSS-REFERENCE TO RELATED APPLICATIONS

This application is based upon and claims the benefit of priority of the prior Japanese Patent Application No. 2008-174003, filed on Jul. 2, 2008, the entire contents of which are incorporated herein by reference.

### FIELD

The present invention relates to a radio communication apparatus and system. The system may include a radio terminal device having a plurality of antennas and a base station conducting communication with the radio terminal device.

### BACKGROUND

In recent years, vigorous research and development efforts have been made for an ITS (Intelligent Transport System).

One example of an ITS is the automatic toll collection system (ETC system: electronic toll collection system) which is already used in toll roads (such as expressways) to permit the users of automobiles running on toll roads to pass through toll gates without stopping. According to the ETC system, the information required for collecting the toll is exchanged by DSRC (dedicated short range communication) between an ETC unit mounted on each vehicle and a roadside unit arranged in the toll gate. The DSRC, which is used for communication between the roadside unit and the on-vehicle unit of the ETC system or the commercial vehicle management system, is classified into the optical type using light and the radio wave type using radio waves, and generally covers the distance of several meters to several hundred meters from the roadside unit as a communicable range.

In the ITS illustrated in FIG. 1, for example, the radio communication is conducted between an on-vehicle unit 20 and a roadside unit 10. The radio communication between the on-vehicle unit 20 and the roadside unit 10, however, is often interfered with by other systems. A case in point is the situation in which an occupant of a vehicle having the on-vehicle unit 20 uses a mobile phone 40. In this case, the transmission power of a base station 30 and the mobile phone 40 are increased if the distance is comparatively large between the mobile phone 40 and the base station 30 covering the cell in which the mobile phone 40 is located. Then, the radio waves transmitted from the base station 30 and the mobile phone 40 interfere with the communication between the on-vehicle unit 20 and the roadside unit 10.

The interference is not limited to the communication between the roadside unit 10 and the on-vehicle unit 20, but as illustrated in FIG. 2, the radio waves from other radio communication systems using a different frequency band may interfere with the radio communication between the base station 50 and the mobile phone 60.

A technique to compensate for the interference will be explained. FIG. 3 illustrates an example of a receiver using the interference compensation technique. The interference compensation technique includes a one-way branch side-lobe canceller in a MIMO (multiple-input multiple-output) system.

The signals received from antennas 1 and 2 are input to an in-phase synthesizer 22. The in-phase synthesizer 22 synthesizes the input signals in phase. In other words, the in-phase synthesizer 22 receives the input signals in diversity. The signals synthesized in phase by the in-phase synthesizer 22 are input to an interference remover 29.

The signal received through the antenna 2 is also input to a phase/amplitude regulator 24. The phase/amplitude regulator 24 adjusts the input signal to the opposite phase and inputs the resulting signal to an opposite-phase synthesizer 26. The phase/amplitude regulator 24, by adjusting the phase and/or amplitude of the input signal, for example, adjusts the input signal to the opposite phase. The signal received through the antenna 1 and the signal input from the phase/amplitude regulator 24 are synthesized by the opposite-phase synthesizer 26 thereby to erase the desired wave. As illustrated in FIG. 4, for example, the opposite-phase synthesizer 26 extracts the interference wave (extracted interference wave) by erasing the desired wave. The interference wave remains by reason of the fact that the desired wave and the interference wave arrive from different directions, and therefore, a phase difference occurs due to the route difference. The interference wave extracted by removing the desired wave is input by the opposite-phase synthesizer 26 to a phase/amplitude regulator 28.

The phase/amplitude regulator 28 adjusts the input interference wave to the phase opposite the interference wave contained in the wave synthesized in phase by the in-phase synthesizer 22. The phase/amplitude regulator 28, by adjusting the phase and/or amplitude of the input signal, for example, adjusts the input signal to the opposite phase. The interference wave thus adjusted by the phase/amplitude regulator 28 is input to the interference remover 29.

The signal synthesized in phase and input from the in-phase synthesizer 22 is synthesized with the interference wave input from the phase/amplitude regulator 28 by the interference remover 29 thereby to compensate for the interference.

In this interference compensation technique, the phase regulation amount and the amplitude regulation amount in the phase/amplitude regulators 24 and 28 are generally controlled automatically.

In FIG. 3, a demodulator is not illustrated. The interference compensation described above may be carried out on the signal either before or after demodulation. Whether the interference compensation is carried out on the signal before or after demodulation may be determined based on the modulation scheme. Use of the modulation schemes including CDMA (code division multiple access), OFDM (orthogonal frequency division multiplexing) and SC-FDMA (single-carrier frequency division multiple access) may be varied with the system involved.

The interference by the radio waves from other systems described above may be reduced also by using a filter in the receiver. The radio waves transmitted from other systems, however, are not completely blocked by the use of the filter in the receiver. In other words, the use of the filter in the receiver does not separate the radio waves transmitted from other systems entirely. Especially, in the case where the transmission power of the radio waves transmitted from other systems is different from the transmission power of the local system, the separation using the filter is even more difficult. It is difficult, therefore, to entirely eliminate the interference by the radio waves transmitted from the other existing systems.

Also, in the interference compensation technique described above, the interference wave is erased by taking advantage of the fact that the desired wave is larger than the interference wave. In the case where the interference wave happens to be larger, therefore, the desired wave is erased and it becomes difficult to extract the interference wave. In FIG. 5, for example, the interference wave is larger than the desired wave, and therefore, the desired wave is erased. The signal extracted as an interference wave is actually a synthesized wave of the desired waves received from the respective antennas.

Also, the interference compensation technique described above is effectively applicable to a case in which the radio wave arrives from a known direction. The interference wave which arrives from an unspecified direction as a radio wave, therefore, is difficult to extract.

### SUMMARY

According to an aspect of the invention, a radio communication apparatus includes a vertical polarization antenna, a horizontal polarization antenna, a receiving-side phase rotation unit configured to rotate a phase of a signal received by the vertical polarization antenna and a phase of a signal received by the horizontal polarization antenna, and a maximum power detector configured to determine a phase associated with a maximum power of the two received signals and to provide the receiving-side phase rotation unit with the phase associated with the maximum power, wherein the receiving-side phase rotation unit rotates the phase of the two received signals by the phase associated with the maximum power.

According to an aspect of the invention, a radio communication apparatus includes a vertical polarization antenna; a horizontal polarization antenna; a transmission-side phase rotation unit for separating a signal to be transmitted into a vertically polarized wave signal and a horizontally polarized wave signal and, by rotating phases thereof, transmitting the signals to the vertical polarization antenna and the horizontal polarization antenna, respectively; and a transmission-side phase rotation control unit to receive phase rotation information indicating at least one of a direction and an angle of a rotation of a phase from a different radio communication apparatus communicating with the radio communication apparatus and to provide the transmission-side phase rotation unit with the phase rotation information, wherein the phase rotation unit rotates the vertically polarized wave signal and the horizontally polarized wave signal based on the phase rotation information.

According to an aspect of the invention, a reception method for a radio communication apparatus includes determining a phase associated with a maximum power of a signal received by a vertical polarization antenna and a phase of a signal received by a horizontal polarization antenna, providing a receiving-side phase rotation unit with the phase associated with the maximum power, and rotating the phase of the signal received by the vertical polarization antenna and the phase of a signal received by the horizontal polarization antenna by the phase associated with the maximum power.

According to an aspect of the invention, a transmission method for a radio communication apparatus includes receiving phase rotation information indicating at least one of a direction and an angle of a rotation of a phase from a different radio communication apparatus communicating with the radio communication apparatus, providing a transmission-side phase rotation unit with the phase rotation information, and rotating a vertically polarized wave signal and a horizontally polarized wave signal based on the phase rotation information for signal transmission.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram explaining the interference by the radio waves transmitted from other systems;

FIG. 2 is a diagram explaining the interference by the radio waves transmitted from other systems;

FIG. 3 is a diagram explaining an interference compensation technique;

FIG. 4 is a diagram explaining an interference compensation technique;

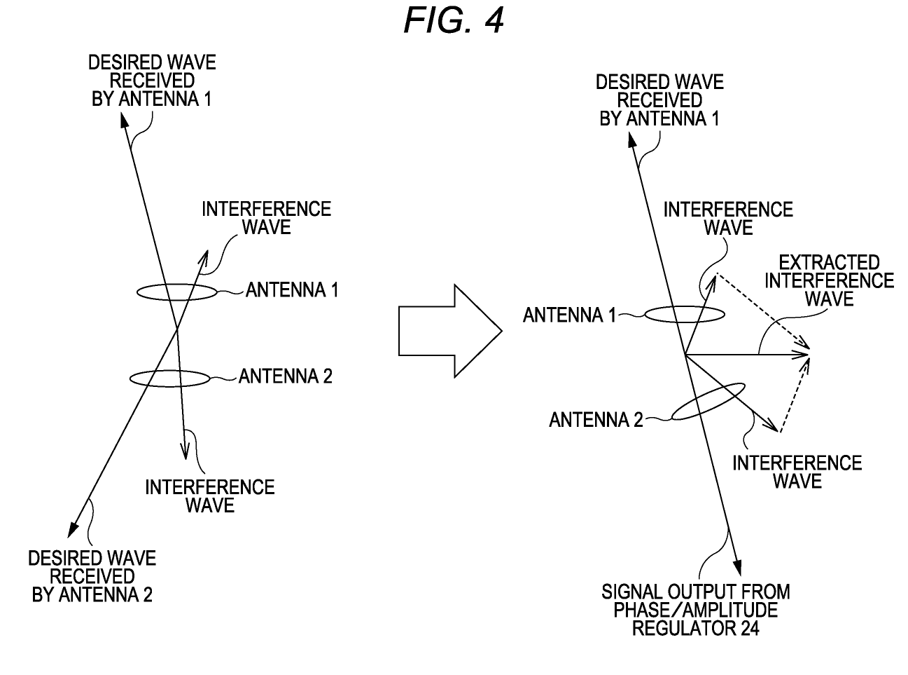

FIG. 5 is a diagram explaining an interference compensation technique;

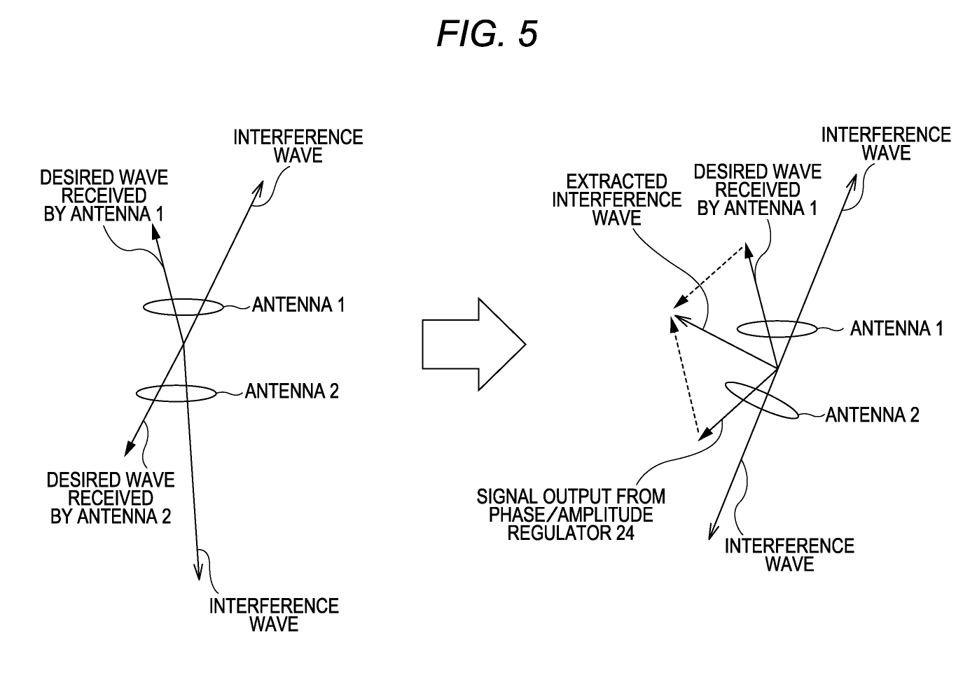

FIG. 6 is an example of a configuration of a radio communication system according to a first embodiment of the invention;

FIG. 7 is an example of a configuration of a radio receiver according to the first embodiment of the invention;

FIG. 8 is an example of a configuration of a radio communication system according to a second embodiment of the invention;

FIG. 9 is an example of a configuration of a radio transmitter according to the second embodiment of the invention;

FIG. 10 is an example of a configuration of a radio receiver according to the second embodiment of the invention; and

FIG. 11 is an example of a configuration of a radio communication system according to a third embodiment of the invention.

### DESCRIPTION OF THE PREFERRED EMBODIMENTS

Embodiments of the present invention will be described in detail below.

### First Embodiment

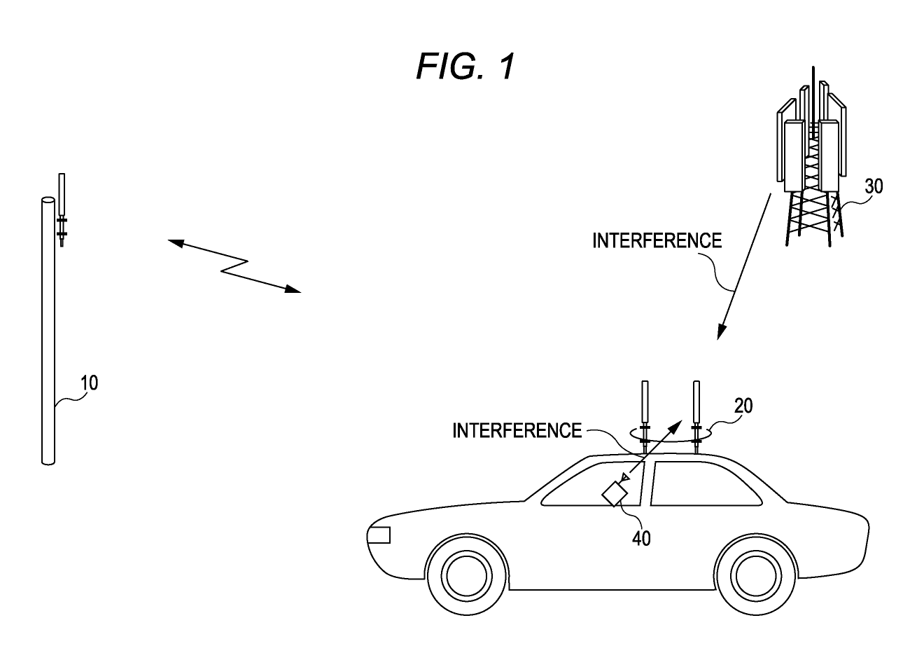

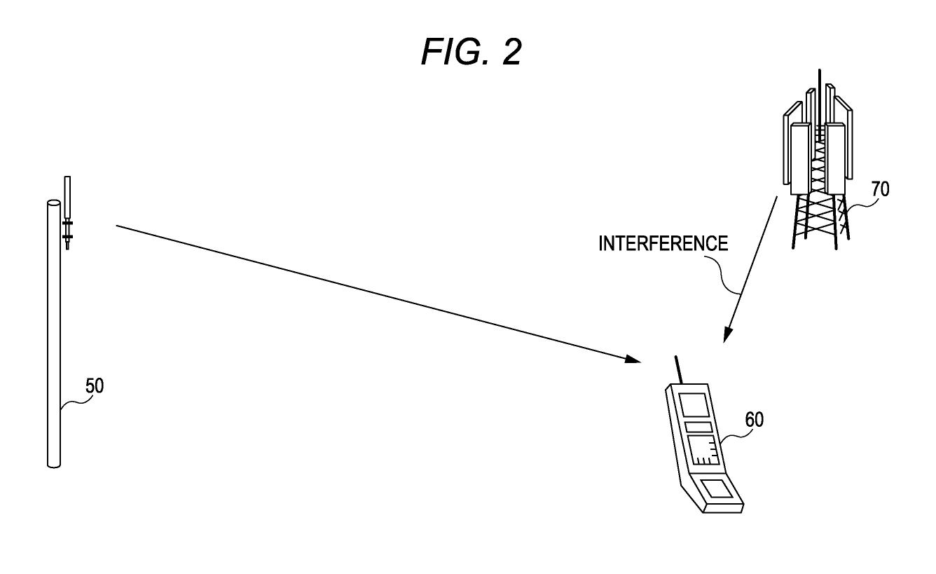

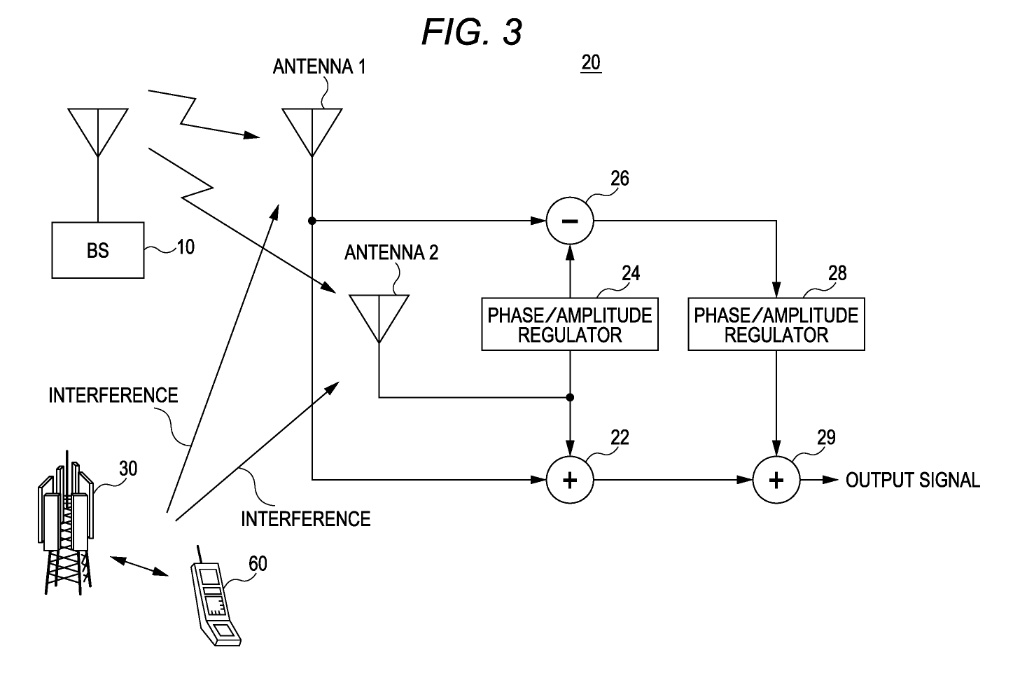

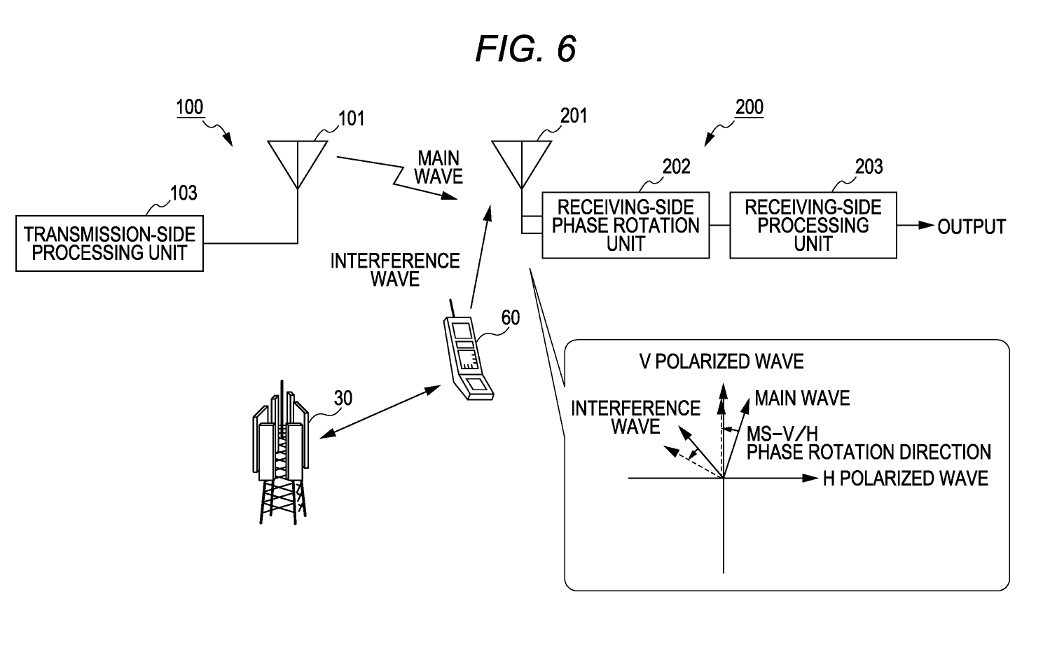

FIG. 6 is an example of a configuration of a radio communication system according to a first embodiment. The radio communication system includes a radio transmitter 100, which may be a roadside unit, and a radio receiver 200, which may be an on-vehicle unit. The radio transmitter 100 includes a transmission-side processing unit 103 for generating a signal to be transmitted, and a transmission-side VH antenna 101 for sending out the signal generated by the transmission-side processing unit 103 in the form of a vertically polarized wave and a horizontally polarized wave. The radio receiver 200, on the other hand, includes a receiving-side VH antenna 201 for receiving the vertically polarized wave and the horizontally polarized wave from the radio transmitter 100, a receiving-side phase rotation unit 202 to rotate the phase of the vertically polarized wave signal and the horizontally polarized wave signal received, and a receiving-side processing unit 203 to process the signals received. The radio transmitter 100 and the radio receiver 200 make up a local system, and a main wave is transmitted as a signal between the radio transmitter 100 and the radio receiver 200. FIG. 6, like FIGS. 1 to 3, illustrates the manner in which the radio waves transmitted from base station 30 and the mobile phone 60 (or the mobile phone 40) interfere with the communication between the radio transmitter 100 and the radio receiver 200.

In the lower right part of FIG. 6, a graph is plotted in which the ordinate represents the strength of the radio wave in the vertical direction and the abscissa the strength of the radio wave in the horizontal direction. In this graph, the vector of one or a plurality of main waves, if any, and the vector of the interference wave are illustrated. As understood from FIG. 6, the vector of the main wave and the vector of the interference wave have different directions. The main wave vector and the interference wave vector are rotated in such a manner that the main vector is positioned in the same direction as the ordinate axis. As a result of the rotation, the main (desired) wave produces maximum power along the direction of the ordinate axis, while the interference wave component along the ordinate axis is reduced. In this way, the main wave is received with the maximum power and affected less by the interference wave.

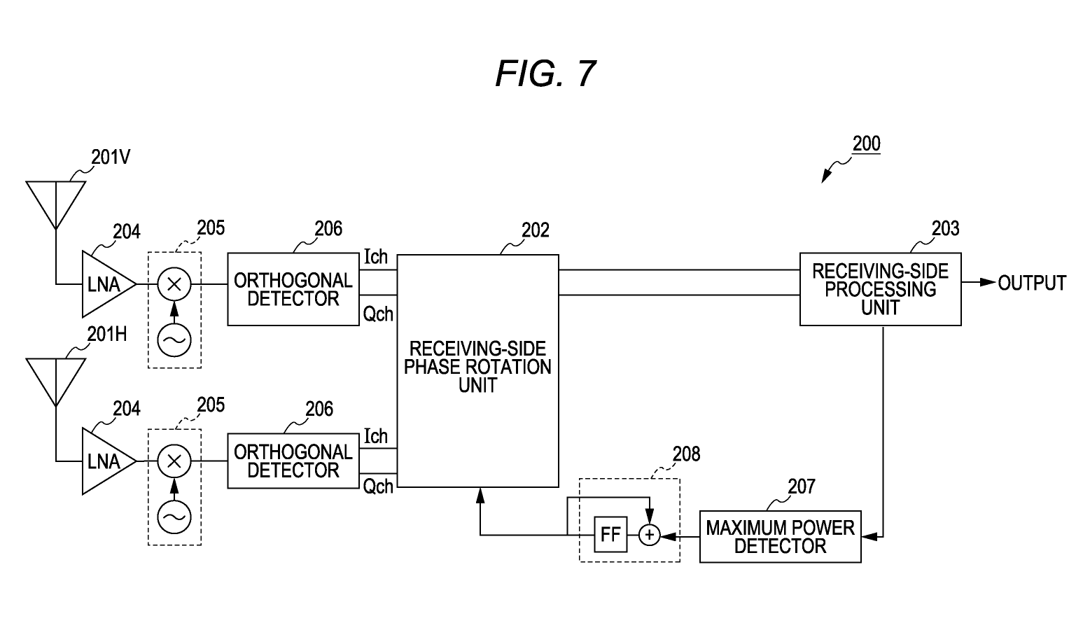

FIG. 7 is an example of a configuration of the radio receiver 200 according to the first embodiment. As illustrated in FIG. 7, the radio receiver 200 includes a vertical polarization antenna 201V, a horizontal polarization antenna 201H, a low-noise amplifier (LNA) 204, a demodulator 205, an orthogonal detector 206 for separating the received signal into the in-phase component Ich and the orthogonal component Qch, a receiving-side phase rotation unit 202, a receiving-side processing unit 203, a maximum power detector 207, and a feedback unit 208.

The receiving-side phase rotation unit 202 rotates the phase of the signals received through the vertical polarization antenna 201V and the horizontal polarization antenna 201H. The receiving-side processing unit 203 receives the received signal from the receiving-side phase rotation unit 202, and provides the maximum power detector 207 with the signal level of the particular signal. The maximum power detector 207 determines, using the least squares method or the like, the phase associated with the maximum power of the signal received from the receiving-side phase rotation unit 202, and provides the receiving-side phase rotation unit 202 with the particular phase associated with the maximum power. At that time, the particular phase may be fed back through the feedback unit 208. The feedback unit 208, configured of a flip-flop and an adder, improves the system stability by preventing a rapid change in the information transmitted from the maximum power detector 207 to the receiving-side phase rotation unit 202. The feedback unit 208 may be omitted. The receiving-side phase rotation unit 202 rotates the phase of the received signal by an amount equal to the phase associated with the maximum power received from the maximum power detector 207. Therefore, the signal output from the receiving-side phase rotation unit 202 contains the vertically polarized wave component.

### Second Embodiment

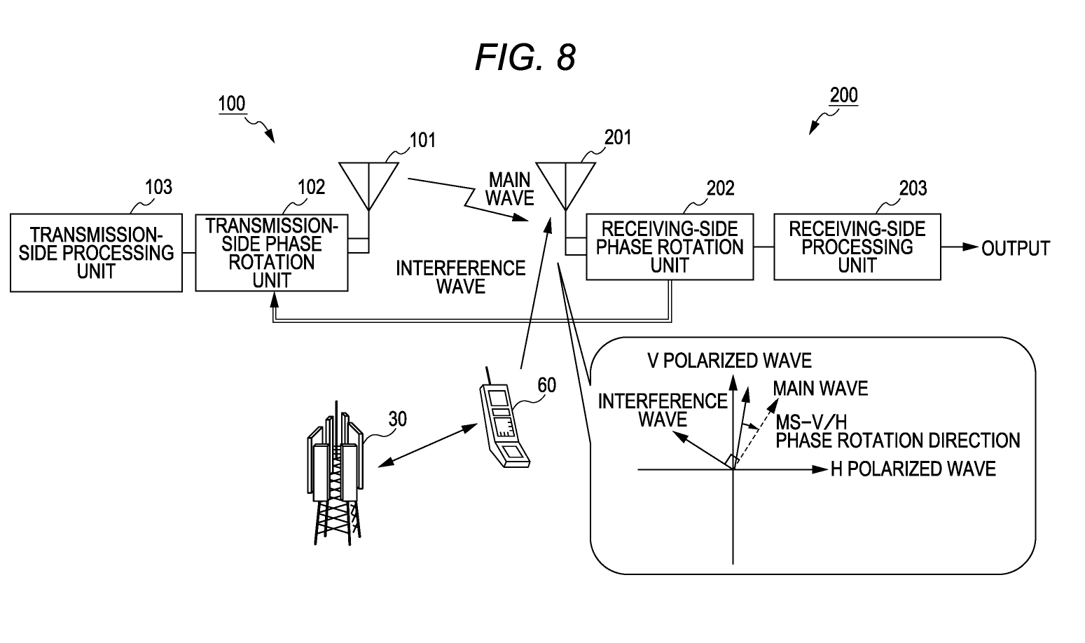

FIG. 8 is an example of a configuration of the radio communication system according to a second embodiment. The configuration of the second embodiment is different from that of the first embodiment illustrated in FIG. 6 in that the radio transmitter 100 further includes a transmission-side phase rotation unit 102 which receives the signal from the receiving-side processing unit 203 of the radio receiver 200.

In the lower right part of FIG. 8, a graph is plotted in which the ordinate represents the strength of the radio wave in the vertical direction and the abscissa the strength of the radio wave in the horizontal direction. In this graph, the vector of one or a plurality of main waves, if any, and the vector of the interference wave are illustrated. As understood from FIG. 8, the vector of the main wave and the vector of the interference wave have different directions. Only the main (desired) wave vector is rotated to the position at an angle of 90° to the interference wave. The resulting 90° difference of the main wave from the interference wave in polarization angle reduces the effect of the interference wave.

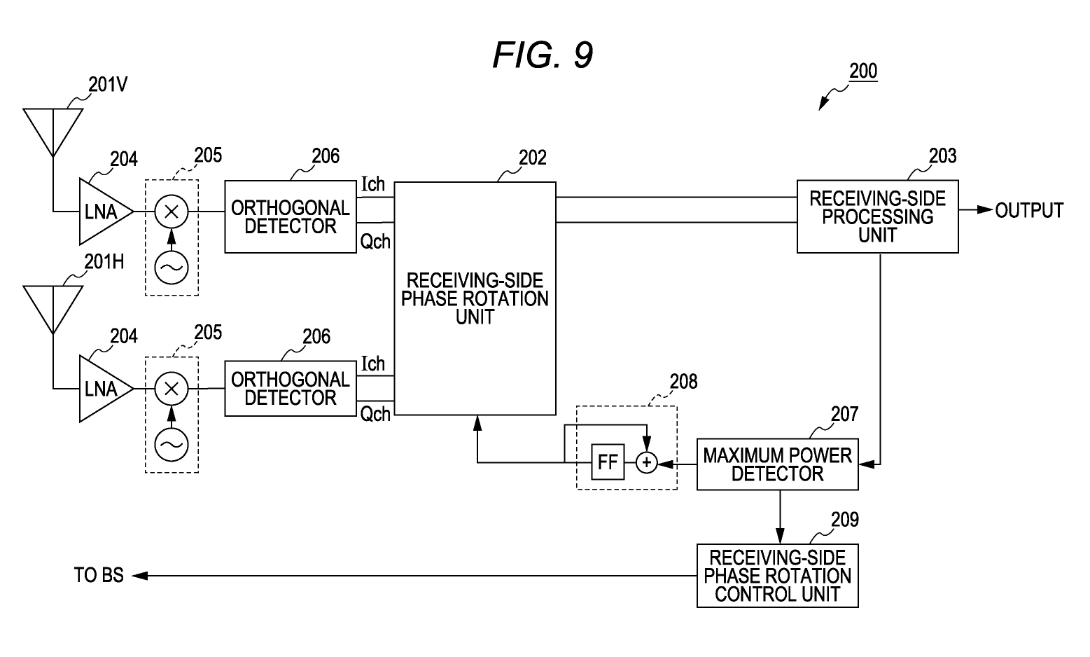

FIG. 9 is an example of a configuration of the radio receiver 200 according to the second embodiment. The radio receiver 200 illustrated in FIG. 9, in addition to the component elements of the radio receiver 200 illustrated in FIG. 7, includes a receiving-side phase rotation control unit 209. The receiving-side phase rotation control unit 209 generates the phase rotation information indicating the direction and/or the angle of the phase rotation by the radio communication apparatus of the other party of communication in such a manner that the signal transmitted from the radio communication apparatus communicating with the radio receiver 200 has the phase associated with the maximum power received from the maximum power detector in a manner similar to the first embodiment. Then, the receiving-side phase rotation control unit 209 transmits this phase rotation information to the radio communication apparatus, i.e., the other party of communication. The radio receiver 200 according to the second embodiment, though described above to rotate the phase, like in the first embodiment, taking the phase associated with the maximum power from the maximum power detector 207 into consideration, may alternatively only transmit the phase rotation information to the other-party radio communication apparatus from the receiving-side phase rotation control unit 209 without notifying the phase associated with the maximum power to the receiving-side phase rotation unit 202 from the maximum power detector 207.

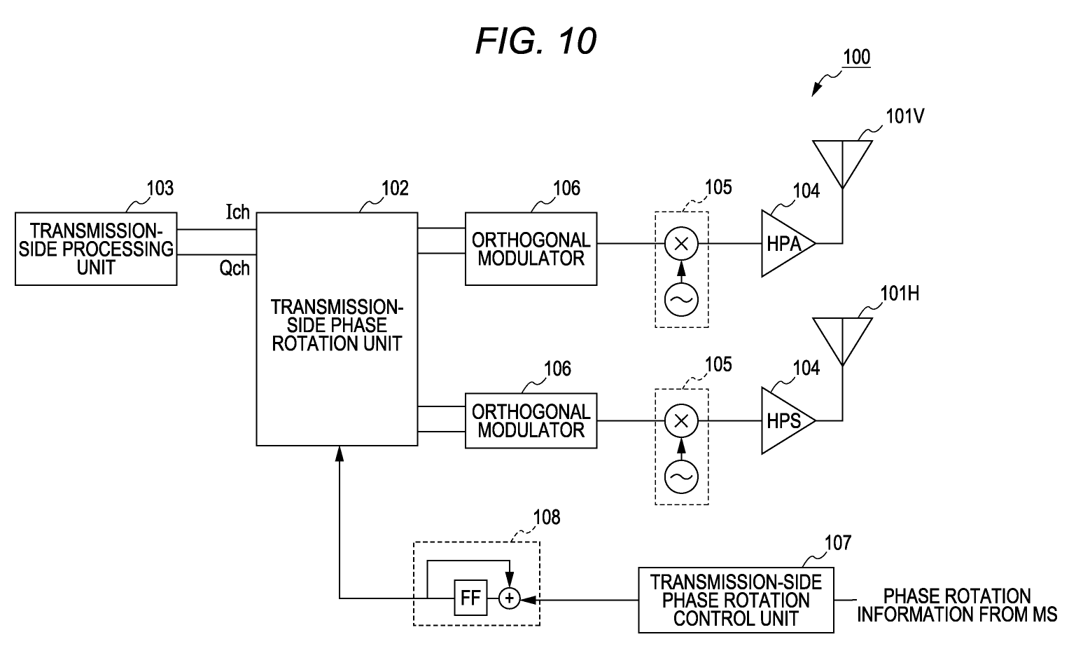

FIG. 10 is an example of a configuration of the radio transmitter 100 according to the second embodiment. As illustrated in FIG. 10, the radio transmitter 100 includes a transmission-side processing unit 103 for generating the in-phase component Ich and the orthogonal component Qch of the transmitted signal, a transmission-side phase rotation unit 102, an orthogonal modulator 106, a modulator 105, a power amplifier (HPA) 104, a vertical polarization antenna 101V, a horizontal polarization antenna 101H, a transmission-side phase rotation control unit 107, and a feedback unit 108.

The transmission-side phase rotation unit 102 separates the signal to be transmitted into a vertically polarized wave signal and a horizontally polarized wave signal, and by rotating the phases thereof, transmits them to the vertical polarization antenna and the horizontal polarization antenna, respectively. The transmission-side phase rotation control unit 107 receives the phase rotation information indicating the direction and/or the angle of phase rotation, from the radio receiver 200 illustrated in FIG. 9 with which the radio transmitter 100 communicates. This information is transmitted to the transmission-side phase rotation unit 102 through the feedback unit 108. The feedback unit 108 is configured of a flip-flop and an adder and improves the system stability by preventing a rapid change in the information transmitted from the transmission-side phase rotation control unit 107 to the transmission-side phase rotation unit 102. The feedback unit 108 may be omitted. The transmission-side phase rotation unit 102 further rotates the vertically polarized wave signal and the horizontally polarized wave signal based on the particular phase rotation information. The signal sent out from the radio transmitter 100, therefore, has a polarization angle of 90° with respect to the interference wave existing in the neighborhood of the radio receiver 200. In other words, since the main wave and the interference wave are orthogonal to each other, the effect of the interference wave is reduced.

The phase rotation information may be transmitted from the radio receiver 200 to the radio transmitter 100 using a transmission power control signal (TPC) or an upward control signal with other communication apparatuses.

### Third Embodiment

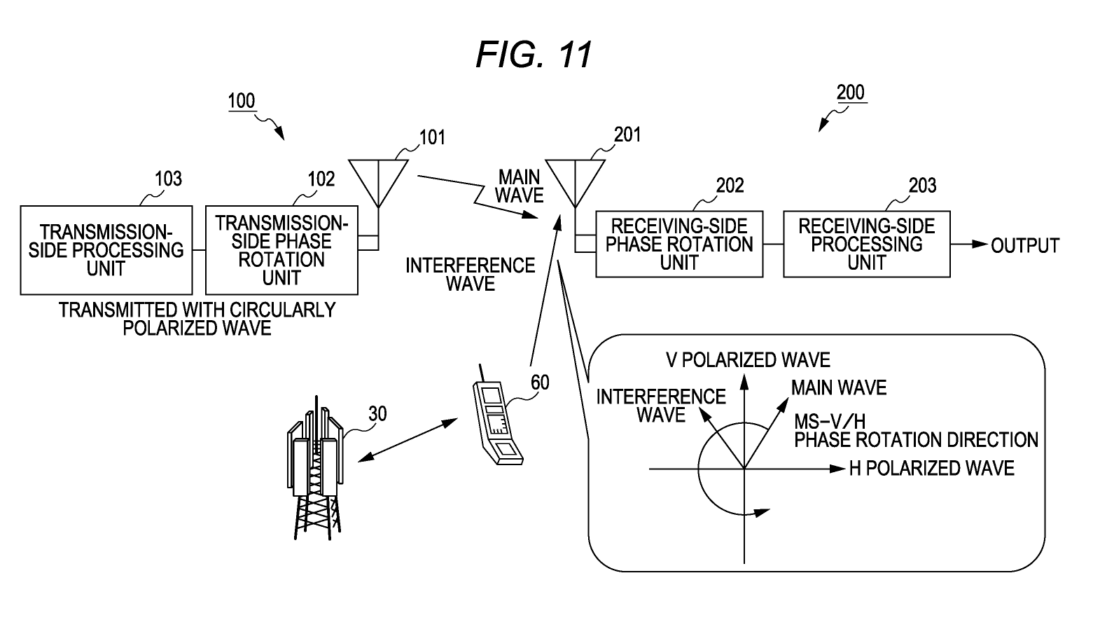

FIG. 11 is an example of a configuration of the radio communication system according to a third embodiment. In FIG. 11, the component elements are similar to those of the second embodiment illustrated in FIG. 8, except that the receiving-side phase rotation control unit 209 and the transmission-side phase rotation control unit 107 do not communicate with each other.

In the lower right part of FIG. 11, a graph is plotted in which the ordinate represents the strength of the radio wave in the vertical direction and the abscissa the strength of the radio wave in the horizontal direction. These strengths are indicated by the vector of one or a plurality of main waves, if any, and the vector of the interference wave. Only the main wave vector is rotated by 360° continuously. Then, although the polarization angle of the main wave coincides with that of the interference wave periodically in the direction of the interference wave vector, the main wave and the interference wave have different polarization angles in the other directions, thereby reducing the effect of the interference wave. This is indicative of the fact that the radio receiver 200 receives a circularly polarized wave signal. As long as the main wave and the interference wave coincide with each other in the vectorial direction, the interference level is increased in the radio receiver 200, resulting in an increased error. This periodic error may be corrected by use of a well-known error correcting function or by retransmission using a well-known retransmission control function.

The configuration of the radio receiver 200 according to the third embodiment is similar to the configuration of the radio receiver 200 according to the second embodiment illustrated in FIG. 9. According to the third embodiment, the receiving-side phase rotation control unit 209 instructs the receiving-side phase rotation unit 202 to receive the circularly polarized signal in such a manner as to maintain the phase difference of ±90° between the signal received by the vertical polarization antenna 201V and the signal received by the horizontal polarization antenna 201H.

The configuration of the radio transmitter 100 according to the third embodiment is similar to the configuration of the radio transmitter 100 according to the second embodiment illustrated in FIG. 10. According to the third embodiment, the transmission-side phase rotation control unit 107 instructs the transmission-side phase rotation unit 102 to transmit the circularly polarized signal in such a manner as to hold the phase difference of ±90° between the vertically polarized wave signal transmitted by the vertical polarization antenna 201V and the horizontally polarized wave signal transmitted by the horizontal polarization antenna 201H.

According to the third embodiment, the radio transmitter 100 and the radio receiver 200 may be set, at the time of installation thereof, to the automatic following mode or a specific circular polarization rate and the initial value of the particular rate. Further, the rotation frequency of the circularly polarized wave may be set to a value of which error correction or retransmission is possible. The rotation frequency of the circularly polarized wave may be set, for example, to a value lower than the communication rate of the unit frame for error correction. As an alternative, the rotation frequency of the circularly polarized wave may be equal to the frequency which can tolerate the number of retransmissible frames upon occurrence of an error.

In the radio receiver 200 according to the third embodiment, like in the first embodiment, the phase is rotated taking the phase associated with the maximum power from the maximum power detector 207 into consideration. As an alternative, the receiving-side phase rotation unit 202 of the radio receiver 200 may simply instruct the receiving-side phase rotation unit 202 to hold the phase difference of ±90° of the signal received from the receiving-side phase rotation control unit 209 without notifying the phase associated with the maximum power from the maximum power detector 207 to the receiving-side phase rotation unit 202.

The first to third embodiments, which deal with the ITS as an example, are applicable also to mobile radio systems and radio communication systems in general in which a main wave and an interference wave may coexist.

In the radio communication apparatus described above, the interference by the radio waves transmitted from other systems may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A radio communication apparatus comprising:
a vertical polarization antenna;
a horizontal polarization antenna;
a receiving-side phase rotation unit configured to rotate a phase of a signal received by the vertical polarization antenna and a phase of a signal received by the horizontal polarization antenna; and
a maximum power detector to determine a phase associated with the maximum power of the two received signals and to provide the receiving-side phase rotation unit with the phase associated with the maximum power,
wherein the receiving-side phase rotation unit rotates the phase of the two received signals by the phase associated with the maximum power.

2. The radio communication apparatus according to claim 1, further comprising:
a receiving-side phase rotation control unit configured to generate phase rotation information indicating at least one of a direction and an angle of the phase rotation by a different radio communication apparatus, and to transmit the phase rotation information to the different radio communication apparatus in such a manner that the signal transmitted from the different radio communication apparatus communicating with the radio communication apparatus has the phase associated with the maximum power received from the maximum power detector.

3. The radio communication apparatus according to claim 2,
wherein the receiving-side phase rotation control unit instructs the receiving-side phase rotation unit to receive a circularly polarized signal in such a manner as to hold the phase difference of ±90° between the signal received by the vertical polarization antenna and the signal received by the horizontal polarization antenna.

4. A radio communication apparatus comprising:
a vertical polarization antenna;
a horizontal polarization antenna;
a transmission-side phase rotation unit for separating a signal to be transmitted into a vertically polarized wave signal and a horizontally polarized wave signal and, by rotating the phases thereof, for transmitting the signals to the vertical polarization antenna and the horizontal polarization antenna, respectively; and
a transmission-side phase rotation control unit for receiving phase rotation information indicating at least one of a direction and an angle of a rotation of a phase from a different radio communication apparatus communicating with the radio communication apparatus, and for providing the transmission-side phase rotation unit with the phase rotation information,
wherein the phase rotation unit rotates the vertically polarized wave signal and the horizontally polarized wave signal based on the phase rotation information.

5. The radio communication apparatus according to claim 4,
wherein the transmission-side phase rotation control unit instructs the phase rotation unit to transmit a circularly polarized signal in such a manner as to hold the phase difference of ±90° between the vertically polarized wave signal and the horizontally polarized wave signal.

6. A reception method for a radio communication apparatus, the reception method comprising:
determining a phase associated with a maximum power of a signal received by a vertical polarization antenna and a phase of a signal received by a horizontal polarization antenna;
providing a receiving-side phase rotation unit with the phase associated with the maximum power; and
rotating the phase of the signal received by the vertical polarization antenna and the phase of a signal received by the horizontal polarization antenna by the phase associated with the maximum power.

7. A transmission method for a radio communication apparatus, said transmission method comprising:
receiving phase rotation information indicating at least one of a direction and an angle of a rotation of a phase from a different radio communication apparatus communicating with the radio communication apparatus;
providing a transmission-side phase rotation unit with the phase rotation information,
rotating a vertically polarized wave signal and a horizontally polarized wave signal based on the phase rotation information for signal transmission.
